(19) United States
(12) Patent Application Publication
(10) Pub. No.: US 2026/0238860 A1
(43) Pub. Date: Aug. 13, 2026

(54) MONITORING A DISPLAY APPARATUS

(71) Applicant: PCCW-HKT DataCom Services Limited, Quarry Bay (HK)

(72) Inventor: Ping Chung NG, Quarry Bay (HK)

(21) Appl. No.: 19/158,017

(22) PCT Filed: Feb. 21, 2024
(86) PCT No.: PCT/IB2024/051634

§ 371 Date: Aug. 19, 2025

(30) Foreign Application Priority Data
Feb. 21, 2023 (HK) 22023068741.4
Feb. 21, 2023 (HK) 22023068742.2

(51) Int. Cl. H04N 21/658; H04N 21/422

(52) U.S. Cl. CPC H04N 21/6582; H04N 21/4222; H04N 21/42221

(57) ABSTRACT

A monitoring device for monitoring a status of a display apparatus, the monitoring device comprising: an infra-red, IR, receiver for detecting an IR signal transmitted from a remote control; a processor configured to determine, from the IR signal, an operating instruction for operating the display apparatus, wherein the operating instruction comprises a channel change instruction and/or a power instruction; and a memory configured to store a current status of the display apparatus, the current status comprising a channel displayed on the display apparatus and/or a power status; wherein the processor is configured to determine an updated status of the display apparatus based at least in part on the operating instruction, and to replace the current status stored in the memory with the updated status.

### FIELD OF THE INVENTION

The present disclosure relates to systems and methods for monitoring a display apparatus, and for determining viewer information relating to a display apparatus.

### DESCRIPTION OF THE RELATED TECHNOLOGY

A monitoring device can be used to monitor a display apparatus, such as a television. A monitoring device may for example keep a record of content being viewed on the display apparatus and/or information relating to audience members viewing the display apparatus. Collected information may be transmitted to a remote system, where it may be collated with information relating to other display apparatuses. Such a monitoring device and/or remote system may be part of a television audience measurement system (TAMS).

Traditionally, TAMS monitoring required a viewer to manually record viewed content in a diary. With the advent of smart phones, viewers have been able enter information about viewers and viewed content into an application on their smart phone, which can transmit data directly to the TAMS. However, such approaches may require the user to remember to enter information, and assume that correct information has been entered. It may therefore be preferable to automate data capture, but such approaches may restrict how the viewer interacts with the display apparatus. For example, a viewer may be required to control the display apparatus using a dedicated TAMS remote control or monitoring app on a smart phone. Conventional TAMS approaches therefore tend to either result in inaccurate data, or else overly restrict the viewer, potentially leading to lack of engagement with the audience monitoring system. Some conventional TAMS systems utilize monitoring devices installed in viewer's homes which record audio. The intention is to record audio played by a television in order to deduce what content is being viewed from the recorded audio. However such devices can also record other sounds around them, raising privacy concerns. Furthermore, transmitting large audio files to a remote server burdens network resources, and processing the audio files to compare them to known content is computationally intensive.

Hence there is a need for systems and methods that are capable of overcoming one or more of the above identified challenges.

### SUMMARY

According to a first aspect, there is provided a monitoring device for monitoring a status of a display apparatus, the monitoring device comprising: an infra-red, IR, receiver for detecting an IR signal transmitted from a remote control; a processor configured to determine, from the IR signal, an operating instruction for operating the display apparatus, wherein the operating instruction comprises a channel change instruction and/or a power instruction; and a memory configured to store a current status of the display apparatus, the current status comprising a channel displayed on the display apparatus and/or a power status; wherein the processor is configured to determine an updated status of the display apparatus based at least in part on the operating instruction, and to replace the current status stored in the memory with the updated status.

Such a monitoring device may allow a viewer to use a conventional remote control to operate the display apparatus, such as a remote control associated or provided with the display apparatus. Thus a viewer may operate the display apparatus as if there was no monitoring device, rather than having to enter viewing information into a diary. The monitoring device may be considered to maintain a ‘digital twin’ of the display apparatus, mirroring changes to the display apparatus to maintain the current status of the display apparatus. The current status can then be used, for example by a TAMS, to determine the content being viewed on the display apparatus. This process does not require audio to be recorded, improving privacy compared to conventional systems. Further, by storing the current status of the display apparatus it is possible to capture relative changes to the display apparatus such as a channel up/down or power on/off command, allowing the viewer to use the relative change buttons on the remote control as normal. In contrast, conventional monitoring systems may require a specific channel or specific power status to be provided. Further, the monitoring device may be used with a traditional, non-smart television (TV). A non-smart TV cannot communicate with a TAMS or with an app running on a viewer's smart phone, so conventionally would require a viewer to maintain a manual diary to record viewing information.

In some examples, the processor may be configured to determine the updated status of the display based at least in part on the operating instruction and on the current status stored in the memory. In some such examples, the operating instruction may comprise the channel change instruction. The channel change instruction may comprise a channel up instruction or a channel down instruction. The processor may be configured to determine an updated channel displayed on the display apparatus based at least in part on the current status stored in the memory and on the channel up instruction or channel down instruction. The updated channel may then be stored as, or as part of, the updated status. Such examples may allow specific viewing information to be extracted from relative change input commands, such as channel up/down, power on/off, or volume up/down/mute commands entered by the viewer on the remote control.

In some examples, the processor may be configured to perform an initialization operation to initialize the current status stored in the memory. The initialization operation may comprise receiving an initialization signal from a user device, such as a portable electronic device (e.g. smart phone or tablet computer). The initialization signal may comprise information specifying a channel for display on the display apparatus and/or information specifying a power status of the display apparatus. The initialization operation may further comprise determining, based at least in part on the initialization signal, an initial status of the display apparatus. The initial status may comprise the channel currently displayed on the display apparatus and/or the current power status. The initial status may be stored in the memory as the current status discussed above. Such examples may provide the monitoring device with initial information specifying an individual displayed channel or power status of the display apparatus. Subsequently, the monitoring device can detect relative change inputs, such as a channel up/down command as discussed above.

In some examples, the display apparatus may be controllable with both an IR remote control and with a user device, for example via an app running on a smart phone. Such examples may provide the user with flexibility in how they control the display apparatus. The monitoring device may also be configured to receive signals from the user device, for example via a radio wave receiver. Advantageously, in some examples the user device/app may provide, at least temporarily, only specific channel/power status inputs options, rather than relative change input options. Thus when the viewer uses the user device to control the display apparatus, specific channel/power information may be provided, which can be used as the initialization signal for the initialization operation. Thus the combination of the monitoring device, remote control, and user device may provide a flexible but robust system for capturing viewing information.

According to a second aspect there is provided a computer-implemented method for monitoring a status of a display apparatus, the method comprising: receiving, at a monitoring device separate to the display apparatus, an infra-red, IR, signal transmitted from a remote control to the display apparatus; determining, from the IR signal, an operating instruction for operating the display apparatus, wherein the operating instruction comprises a channel change instruction and/or a power instruction; determining, based at least in part on the operating instruction, a current status of the display apparatus, the current status comprising a channel displayed on the display apparatus and/or a power status; and storing the current status of the display apparatus in a memory.

According to a third aspect there is provided a computer program comprising instructions, which, when the program is executed by a computer, cause the computer to perform the method of any of embodiment of the second aspect.

According to a fourth aspect there is provided a computer-readable medium comprising instructions which, when executed by a computer, cause the computer to perform the method of any embodiment of the second aspect.

According to a fifth aspect there is provided a computer-implemented method of verifying, in an audience measurement system, viewer information associated with a display apparatus, wherein the audience measurement system is for monitoring viewers of broadcast media, and wherein the method comprises: receiving, by the audience measurement system, initial viewer information, the initial viewer information identifying a first user as viewing the display apparatus; capturing, by a monitoring device of the audience measurement system associated with the display apparatus, a wireless signal transmitted between a user device and an external system (e.g. transmitted by a user device and directed to the external system, or transmitted by the external system and directed to the user device); and verifying, by the audience measurement system, the initial viewer information based at least in part on the wireless signal.

Such a method may provide an automated process for verifying viewer-entered (or otherwise derived) viewer information. The viewer information may specify one or more viewers of the display apparatus, and may specify information associated with content viewed on the display apparatus. In contrast, conventional audience measurement systems may rely entirely on viewer-entered information, which can be prone to error. Methods of the fifth aspect therefore may improve the accuracy of data collected by an audience measurement system. Methods of the fifth aspect may verify information automatically by ‘sniffing’ signals not intended for the audience measurement system/monitoring device. Thus these methods may automatically and passively verify viewer information, without needing active participation of the viewer, viewer's device (e.g. smart phone), and/or the display apparatus. As such, these methods may provide for simple (e.g. not burdensome for the viewer) but accurate audience measurement system.

In some examples, the initial viewer information may be generated based on information directed to the audience measurement system. For example, viewer information may be generated based on a viewer input, information received from a viewer's device, and/or information received from a remote server. Thus the initial generation of viewer information and the verification of the viewer information may use distinct processes, improving accuracy of the collected information.

In some examples, the user device may be associated with the first user. In such examples, verifying the initial viewer information may comprise determining, by the audience measurement system, and based at least in part on the wireless signal, that the first user is not viewing the display apparatus. Thus verifying the initial viewer information may comprise determining that the initial viewer information is incorrect. The first user may then be removed from the initial viewer information, i.e. correcting the original information. Such examples may provide automated correction of user-entered information, such that the monitoring system considers the first user to have not viewed the display apparatus at all (at least in a present session). This may provide more accurate viewer information for the audience measurement system.

In some examples, determining that the first user is not viewing the display apparatus may comprise determining, based in part on a strength of the wireless signal (e.g. a signal to noise ratio), that the user device is outside of a viewing zone associated with the display apparatus.

Alternatively or additionally, determining that the first user is not viewing the display apparatus may comprise determining, by the audience measurement system, that the wireless signal is associated with streaming media displayed on the user device. For example, the header and/or payload of a data packet of the wireless signal may be read to determine if the packet relates to streaming media, and is transmitted by, or directed to, the user device of the first user. If the user device is displaying streaming media, it may be determined that the first user is not actually viewing the display apparatus. This may provide automated correction of viewer information, for example where the location of the first user suggests they would be viewing the display apparatus (e.g. they are in the viewing zone), or where the first user or another user enters the first user as viewing the display apparatus even though the first user is not actually engaging with the content on the display apparatus.

In some examples, the user device may be associated with a second user not identified in the initial viewer information. Verifying the initial audience information may comprise determining, by the audience measurement system, and based at least in part on the wireless signal, that the second user is viewing the display apparatus. Thus methods may automatically add additional viewers to the initial viewer information, as well as removing incorrectly identified viewers.

According to a sixth aspect there is provided a monitoring device for monitoring a display apparatus, the monitoring device comprising: a wireless signal receiver for detecting a wireless signal transmitted by a user device; one or more processors; and one or more computer-readable media storing instructions that, when executed, cause the monitoring device to perform the method of any embodiment of the fifth aspect.

According to a seventh aspect there is provided an audience measurement system comprising the monitoring device of any embodiment of the sixth aspect.

According to an eighth aspect there is provided an audience measurement system comprising: one or more processors; and one or more computer-readable media storing instructions that, when executed, cause the monitoring device to perform the method of any embodiment of the fifth aspect.

According to a ninth aspect there is provided a computer program comprising instructions, which, when the program is executed by a computer, cause the computer to perform the method of any embodiment of the fifth aspect.

According to a tenth aspect there is provided a computer-readable medium comprising instructions which, when executed by a computer, cause the computer to perform the method of any embodiment of the fifth aspect.

Further features and advantages will become apparent from the following description of embodiments, given by way of example only, which is made with reference to the accompanying drawings.

### BRIEF DESCRIPTION OF THE DRAWINGS

FIG. 1 illustrates an example monitoring device for monitoring a display apparatus.

FIG. 2 shows an example method of maintaining a current status of the display apparatus in the monitoring device.

FIG. 3 shows an example method for initializing the current status stored in the monitoring device.

FIG. 4 illustrates an example audience measurement system for verifying viewer information associated with a display apparatus.

FIG. 5 shows an example method of verifying viewer information.

FIGS. 6a and 6b illustrate a process of detecting whether a user is within a viewing zone of the display apparatus to verify the viewer information.

### DETAILED DESCRIPTION

It is to be appreciated that the teaching set forth herein is by way of example only, not by limitation. The concepts herein are not limited to use or application with any specific systems or methods for monitoring a display apparatus or determining viewer information. Thus, although the instrumentalities described herein are for the convenience of explanation shown and described with respect to exemplary embodiments, it will be understood and appreciated that the principles herein may be applied equally in other types of systems and methods for monitoring a display apparatus or determining viewer information.

### Monitoring Device

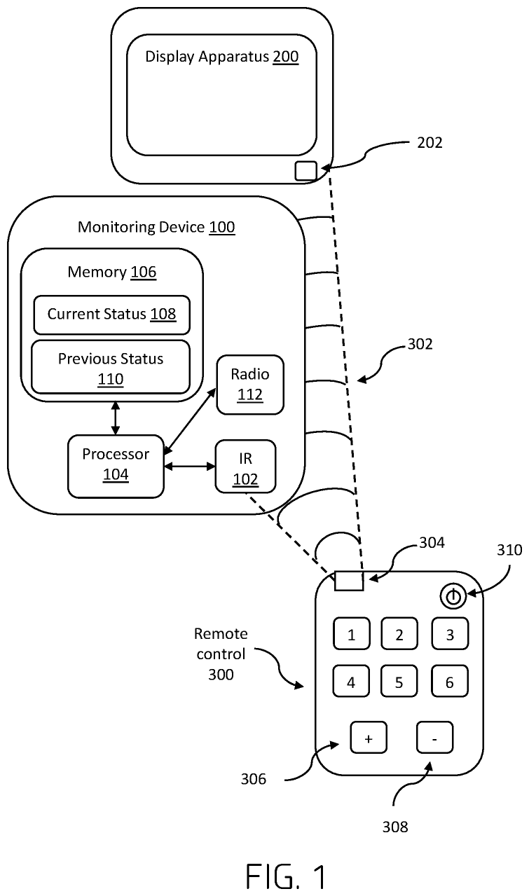

FIG. 1 illustrates an example monitoring device 100 for monitoring a display apparatus 200. Display apparatus may be controlled by a remote control 300.

The monitoring device 100 may be, or may be part of, an audience measurement system, such as a television audience measurement system (TAMS). The monitoring device 100 may be co-located with the display apparatus 200. For example, the monitoring device may be in the same building or room, or located adjacently to the display apparatus 200. The monitoring device may be a stand-alone device, separate from the display apparatus 100. In some examples the monitoring device 100 may be incorporated into a component associated with the display apparatus 200 such as a set-top box.

The display apparatus 200 may be or comprise a television (TV), a non-smart TV, a smart TV, a set-top box, or a streaming device. The display apparatus 200 may be for displaying media, for example broadcast media. The display apparatus 200 may comprise an antenna connection, network connection, or any other means for receiving media from a remote source.

The remote control 300 may transmit signals for controlling the display apparatus 200 based on inputs from a user, e.g. a user pressing buttons on the remote control 300. Although presented here as physical buttons as in a conventional remote control, in other examples the remote control 300 may comprise a display having a graphical user interface (GUI) showing selectable GUI elements representing buttons, or any other user input means.

The remote control 300 may directly control the display apparatus, i.e. no intermediate component is required to receive the signal to control the TV. The remote control 300 may be associated with the display apparatus 200, for example the remote control 300 may have been provided with the display apparatus 200, and/or may be designed specifically for the display apparatus 200. The remote control 300 may have the sole function of controlling the display apparatus 200, or similar display apparatuses.

The remote control 300 may be an infra-red (IR) remote control. In particular, remote control 300 may comprise an IR transmitter 304 configured to transmit an IR signal 302 for controlling the display apparatus. The display apparatus 200 may comprise an IR receiver 202 for receiving the IR signal 302. The IR signal 302 may encode an operating instruction, based on user input, that the display apparatus 302 is configured to extract. The operating instruction may for example be a channel change instruction for changing a channel displayed on the display apparatus 200. For example, a user may have selected a specific channel button (e.g. a numbered button in the illustrated example), or a channel change button such as a channel up button 306 or channel down button 308. Channel up/down button 306, 308 may be intended to increment the channel number by 1 (or any other number). The operating instruction may be a power instruction for changing a power status of the display apparatus 200. For example the power instruction may control the display apparatus 200 to turn on or off, or to enter or leave a standby mode. A user may have selected a power toggle button 310, toggling the display apparatus 200 from on to off, or from off to on. The operating instruction may be a volume instruction for changing a volume of audio emitted by the display apparatus 200 and/or one or more speakers associated with the display apparatus 200. For example the volume instruction may increment a volume level up, increment a volume level down, or toggle a mute setting on or off. The user may have selected a corresponding volume button on the remote control 300. Additional operating instructions may toggle subtitles on or off, or select an audio mode.

As illustrated in FIG. 1, the IR signal 302 from remote control 300 may also be received by the monitoring device 100. The monitoring device 100 comprises an IR receiver 102 for detecting the IR signal 302. For example the IR receiver 102 may be or comprise a photodiode or a phototransistor for converting the IR signal 302 into an electrical signal. In some examples both the display apparatus 200 and the monitoring device 100 may separately receive the IR signal(s) 302. In other examples the monitoring device 100 may be positioned to intercept the IR signal 302, blocking it from the display apparatus 200. In such cases the monitoring device 100 may relay the IR signal, or any other signal type, to the display apparatus 200 for controlling the display apparatus 200.

The monitoring device 100 comprises a processor 104. The processor 104 may receive the IR signal 302, or a representation of the IR signal 302, from the IR receiver 102. The processor 104 is configured to determine, from the IR signal 302, an operating instruction for operating the display apparatus. In other words, the processor 104 may extract the operating instruction encoded into the IR signal 302 similarly to how display apparatus 200 interprets the IR signal 302. In particular examples, the IR signal 302 may comprise a signal code representing the operating instruction. The processor 104 may be configured to determine the operating instruction from the IR signal 302 by comparing the signal code to a plurality of stored codes, each stored code associated with a respective known operating instruction.

A matching code may be identified from the plurality of stored codes (e.g. stored in memory 106, discussed below) based on a similarity between the signal code and the stored code. The known operating instruction associated with the matching code may be identified as the operating instruction of the IR signal. In some examples, the signal code set may be specific to the manufacturer or model of the display apparatus 200. The processor 104 may therefore compare the signal code to a wide range of stored codes to identify a matching code. However, this process may be computationally burdensome, and may not be accurate if multiple manufacturers use similar codes. Advantageously, however, some examples of the monitoring device 100 may be able to receive signals from a user's computer device, such as a smart phone. In such examples, a user may be able to select, via an application on their device, the manufacturer and/or model of the display apparatus 200, and transmit this information to the monitoring device 100. Processor 104 may then only have to search known codes associated manufacturer and/or model input by the user.

The processor 104 may be or comprise a microprocessor, a general-purpose processor, an application specific integrated circuit (ASIC), a digital signal processor (DSP), a field programmable gate array (FPGA) or other programmable logic device, discrete hardware components, a discrete gate or transistor logic, or any suitable combination thereof capable of performing the functions described herein. The processor 104 may also be implemented as a combination of computing devices, such as, for example, a plurality of processors, a combination of a DSP and a microprocessor, one or more microprocessors in conjunction with a DSP core, or other such configuration.

The monitoring device 100 further comprises a memory 106, or is communicatively coupled to a memory device. Memory 106 is configured to store a current status 108 of the display apparatus. The current status 108 may be or comprise a channel displayed on the display apparatus, a power status (i.e. on or off), a volume status (e.g. a volume setting, volume up, volume down, mute on, mute off), an audio mode status (e.g. surround sound), and/or a subtitle status (i.e. subtitles on or off, and/or language of subtitles). The current status 108 may act as a ‘digital twin’ of the display apparatus 200, representing the state of the display apparatus 200 at the current time. The current status 108 can be updated when the status of the display apparatus 200 changes, maintaining an up-to-date representation of the state of the display apparatus 200. As discussed further below, the current status 108 may be determined and updated based on received IR signals 302 from remote control 300, and in particular based on the operating instruction determined by the processor 104. Memory 106 may also store one or more previous statuses 110. A previous status 110 may be a copy of a previous current status 108, and may be stored with an associated time or time period associated with that previous current status 108 (e.g. the time or time range at which a particular channel was viewed on the display apparatus 200). The current status may comprise, or may be associated with, additional information such as information about who is viewing the display apparatus 200, computing devices near the display apparatus 200 and the like.

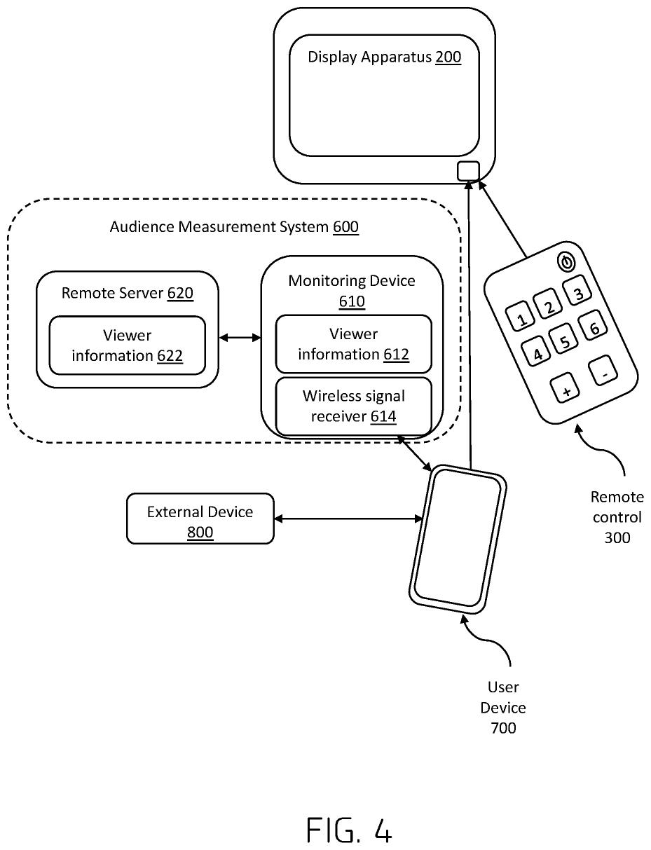

The current status 108 (or a previous status 110) may be used to identify media content displayed on the display apparatus 200. For example, a channel displayed on the display apparatus 200, as stored in the current/previous status 108,110, may be associated with a time. The processor 104 may be configured to compare the channel and the time to a content schedule (e.g. a look-up table) to determine the content on that channel at that time. The content may also be stored as part of the current/previous status 108, 110. In other examples the content viewed may be determined by a remote server (e.g. remote server 622 shown in FIG. 4) which receives the current status 108 and/or a previous status 110 from monitoring device 100. Thus, in contrast to conventional TAMS devices, monitoring device 100 may automatically determine content viewed on the display apparatus 200 without recording audio of the surrounding environment, eliminating the privacy concerns and computational burden associated with audio recording and processing.

In some examples, memory 106 may also store viewer information associated with a status 108, 110 of the display apparatus 200. For example, the current status 108 may be associated with one or more viewers determined to be currently viewing the display apparatus 200. The viewer information may be determined by the method discussed below in relation to FIGS. 4-6b. The viewer information may be determined based on the current/previous status 108, 110. For example, if the volume of the display apparatus 200, as reflected in the current/previous status 108, 110 is low (below a predetermined threshold) or muted, monitoring device 100 may determine that no one is actually viewing the display apparatus 200 and so may automatically remove one or more viewers from the viewer information. Thus the current status 108 may be used to provide more accurate information about viewers of the display apparatus 200.

Memory 106 may include one or more volatile memory, such as a Random Access Memory (RAM) and non-volatile memory, such as Read Only Memory (ROM) or a solid state drive (SSD) such as Flash memory. Memory 106 may include other storage media, such as, for example, magnetic or optical, and may be in a format such as compact disc (CD), digital versatile disc (DVD). Memory 106 may be removable, such as SD or USB type drives or non-removable from the monitoring device 100.

In some examples the monitoring device 100 may further comprise a network interface for transmitting a current/previous status 108, 110 of the display apparatus 200 to a remote server over a network. The remote server may be part of an audience measurement system, and may be used to collect audience measurement data (e.g. display apparatus status, viewed content, viewer information) from a plurality of monitoring devices 100. The network connection may for example be an ethernet interface, wireless (e.g. Wi-Fi) interface, cellular interface, etc.

### Updating Current Status of the Display Apparatus

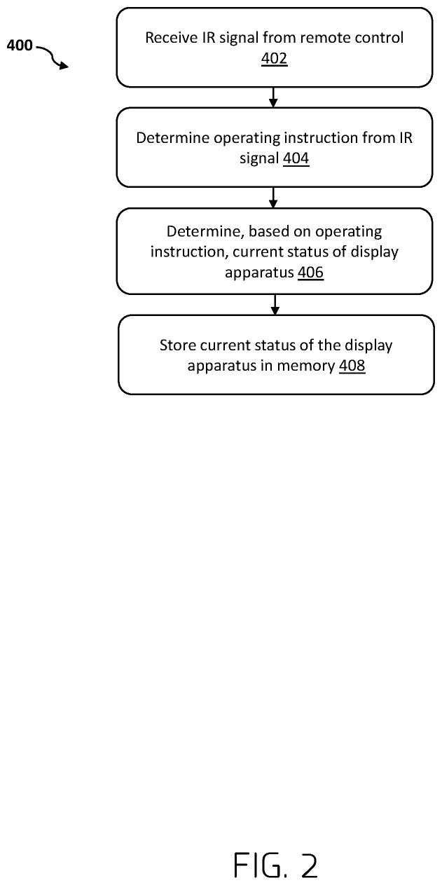

FIG. 2 illustrates an example method 400 for storing a current status 108 of the display apparatus 200 in memory 106. Method 400 may be performed by monitoring device 100.

Method 400 comprises operation 402, at which an IR signal 302 transmitted from a remote control 300 to the display apparatus 200 is received by the monitoring device 100, for example via IR receiver 102.

Method 400 comprises operation 404, comprising determining, from the IR signal 302, an operating instruction for operating the display apparatus 200. The operating instruction may comprise a channel change instruction and/or a power instruction, such as those described above in relation to operating instructions transmitted by remote 300. Operation 404 may be performed by processor 104, discussed above.

Method 400 comprises operation 406, comprising determining, based at least in part on the operating instruction, a current status of the display apparatus (i.e. the status of the display apparatus 200 after implementing the operating instruction encoded in the IR signal 302). The current status may comprise a channel displayed on the display apparatus and/or a power status. Operation 406 may be performed by processor 104, discussed above.

In some cases, the IR signal 302 may encode a specific channel selection or power status. In such cases the processor 104 may determine the current status 108 directly from the specific channel selection or power status encoded in the IR signal 302. In other cases, however, the IR signal 302 may encode a ‘relative change’ operating instruction, such as a channel up, channel down, volume up, volume down, or power toggle instruction. In such cases, processor 104 may determine the (new/updated) current status 108 of the display based at least in part on the operating instruction and on the (previous) current status 108 stored in the memory 106. For example, the operating instruction may comprise a channel change instruction. The channel change instruction may comprise a channel up instruction or a channel down instruction. The processor 104 may be configured to determine an updated channel displayed on the display apparatus based at least in part on the current status 108 stored in the memory 106 and/or on the channel up instruction or channel down instruction. For example, processor 104 may retrieve the previous channel number and increment it by one to determine the new channel number. Similarly, if the operating instruction comprises a power toggle instruction, the processor 104 may determine the new power status to be the opposite of the previous status, e.g. the new status 108 is ‘on’ or the previous status is ‘off’, and vice versa. Thus, by maintaining the ‘digital twin’ of the display apparatus 200 as represented by the stored current status 108, monitoring device 100 is able to capture viewing information even when a user presses a ‘relative change’ button on remote control 300, such as channel up/down buttons 306, 308 or power toggle button 310. Thus, the monitoring devices 100 of the present disclosure may allow a user the flexibility to use a traditional TV remote control as they like, whilst capturing all viewing information, even for non-smart TVs.

Method 400 concludes with operation 408, comprising storing the (new/updated) current status 108 of the display apparatus 200 in memory 106. Operation 408 may comprise replacing the (previous) current status 108 in the memory 106 with the newly determined current status 108. The (previous) current status 108 may be deleted, or may be stored in memory 106 as a previous status 110.

### Receiving Signals From a User Device and IR Remote Control

Advantageously, in some examples the monitoring device 100 may be able to receive signals from both the IR remote control 300 and from a user device, such as a smart phone running an application for controlling the display apparatus 200 and/or for interacting with the monitoring device 100. Such examples may provide the user with extra flexibility in how they control the display apparatus 200. To this end, the monitoring device 100 may in some examples comprise a radio wave receiver 112. Radio wave receiver 112 may be for receiving a radio wave signal from a user device. For example radio wave receiver 112 may be a Wi-Fi receiver for receiving Wi-Fi signals, and/or a Bluetooth receiver for receiving Bluetooth signals.

Such signals may comprise an operating instruction for controlling the display apparatus 200, similarly to the IR signal 302 discussed above. The processor 104 may be configured to determine a current status of the display apparatus 200 based at least in part on the operating instruction encoded in the radio wave signal. Alternatively the signal may encode user-entered information specifying a status of the display apparatus 200, but not intended to control the display apparatus 200.

In some examples, the wireless signal may be directed to the monitoring device 100. For example, the user device may comprise an application associated with an audience measurement system of which monitoring device 100 is part. The user may select a control (e.g. channel, volume, power control) on the app, and the app may cause the radio wave signal to be transmitted in response. The application may be for controlling the display apparatus 200, or simply for collecting information about the display apparatus 200 from the user (“user-entered information”). The monitoring device 100 may relay a signal (e.g. radio wave or IR) to the display apparatus 200 based on the received radio wave signal. For example, the user may select a channel on their smart phone, which may be transmitted as a radio wave signal to the monitoring device 100, which may then transmit an IR signal to the display apparatus 200 incorporating the appropriate operating instruction for controlling the display apparatus 200.

In some examples, the radio wave signal may be directed to the display apparatus 200 itself, i.e. it may be intended to be received by the display apparatus 200. The monitoring device 100 may capture or intercept the radio wave signal, and extract information contained within it to determine a status of the display apparatus 200. The monitoring device 100 may then re-transmit the radio wave signal, or transmit any other type of signal, to the display apparatus 200. As such, radio wave receiver 112 may be a wireless signal ‘sniffer’, for example a Wi-Fi sniffer. Further details on capturing wireless signals directed to other systems is provided below in relation to FIGS. 4 to 6b.

In some examples, the user device may be a computing device, a portable computing device, a smart phone, a tablet computer, a portable computer, or a wearable device.

### Initializing the Status

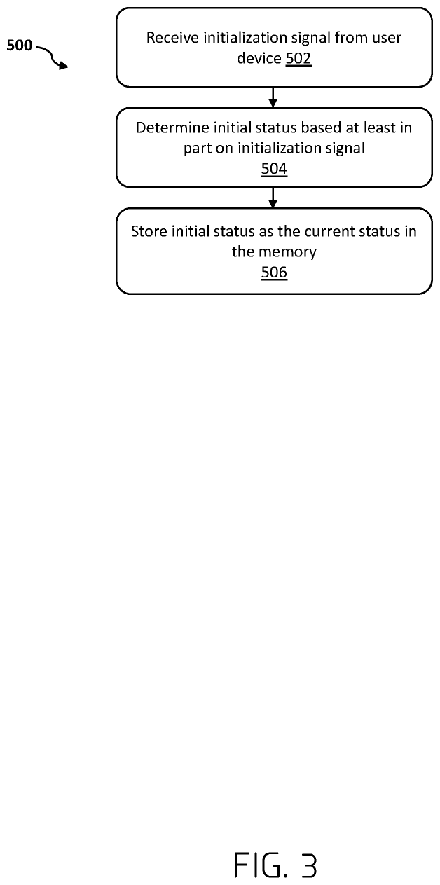

FIG. 3 illustrates an example method 500 for initializing the current status 108 stored in memory 106. Method 500 may be used to provide specific information about the status of the display apparatus 200, so that future statuses can be determined from a ‘relative change’ command (e.g. channel up/down). Method 500 highlights a particular advantage of providing a monitoring device 100 capable of receiving both IR signals from a traditional remote control and radio wave signals from a user device; namely providing a mechanism to capture initialization information so that the user can otherwise use the remote control 300 as normal, including pressing the ‘relative change’ buttons, without any loss of viewing information.

Method 500 comprises operation 502, comprising receiving an initialization signal from the user device. The initialization signal may comprise information specifying a status of the display apparatus 200. For example the initialization signal may specify a channel for display (or that is currently being displayed) on the display apparatus 200 and/or information specifying a power status of the display apparatus.

Although termed here as an “initialization signal”, it is to be noted that the initialization signal may in fact be a radio wave signal or IR signal as discussed above, for controlling the display apparatus 200. An initialization signal may be any signal encoding specific information (e.g. a specific channel), rather than a ‘relative change’ command. Thus the user, or user device, may not realize they are providing an initialization signal. For example, an application on the user's device may present control options for controlling the display apparatus 200 consisting only of specific inputs, without any ‘relative change’ options. Thus, any time the user decides to control the display apparatus 200 with their user device, they may effectively be forced into providing specific information which the monitoring device 100 can use as an initialization signal.

Method 500 comprises operation 504, comprising determining, based at least in part on the initialization signal, an initial status of the display apparatus. The initial status may for example comprise the channel currently displayed on the display apparatus and/or the current power status. The initial status may be determined similarly to determining the current status in operation 406 of method 400, for example by extracting an operating instruction from the initialization signal.

Method 500 further comprises operation 506, comprising storing the initial status in the memory as the current status. Subsequently method 400 may be used to update the status based on newly received inputs.

Method 500 may be performed periodically, or may be performed each time a signal is received that comprises specific information (e.g. when a user uses their user device rather than IR remote control 300 to control display apparatus 200). Method 500 may be performed during initial set-up of the monitoring device 100, and/or each time monitoring device 100 is powered on. In some examples, the monitoring device 100 may be configured to request the initialization signal from the user device. For example, the monitoring device 100 may request an initialization signal if no suitable signal has been received for a predetermined period of time. The user device may notify the user to prompt user input generating the initialization signal. In other examples the user device may be the remote control 300. The monitoring device 100 may request an initialization signal from the viewer by presenting a notification on the display apparatus 200 requesting that the user press a specific channel button or buttons to select a channel, rather than pressing a channel change button. Similarly the monitoring device 100 may request an initialization signal relating to a power status or volume level, for example by assigning individually numbered channel buttons to a particular power/volume status, and requesting that the viewer press an appropriate button on remote 300 to indicate the current power/volume status.

### Verifying Viewer Information

### Overview of System

FIG. 4 illustrates an example audience measurement system 600 comprising a monitoring device 610. Monitoring device 610 may be the same or substantially the same as monitoring device 100, and/or may incorporate any or all of the features discussed above in relation to monitoring device 100. In particular monitoring device 610 may comprise an IR receiver 102, processor 104, memory 106 and/or radio wave receiver 112.

Audience measurement system 600 may be for monitoring a display apparatus 200 and viewers of the display apparatus 200. In particular, audience measurement system 600 may be configured to determine viewer information specifying who is watching the display apparatus 200, for example at a particular time and/or whilst particular content is displayed on the display apparatus 200. Audience measurement system 600 may be a TV audience measurement systems (TAMS). Audience measurement system 600 may be for monitoring viewers of broadcast media. Broadcast media may refer to content transmitted to a mass audience, for example via radio waves or cable transmission.

As discussed above, display apparatus 200 may be a TV or any other display. Display apparatus 200 may be controllable via a remote control 300 and/or via a user device 700. For example, an application running on the user device 700 may provide user-selectable objects for controlling the display apparatus 200. In some examples display apparatus 200 may be controlled via monitoring device 610. For example a remote control/user device may transmit a signal to the monitoring device 610, which may then transmit a signal to control the display apparatus. Monitoring device 610 may also be configured to receive signals from the user device 700 and/or a remote control 300 comprising viewer information or other data for the audience monitoring system 600.

Monitoring device 610 may be co-located or otherwise associated with the display apparatus 200, for example located in the same building or room as the display apparatus 200. The monitoring device may be a stand-alone device, or may be incorporated into another component associated with the display apparatus 200, such as a set-top box. In some examples, monitoring device 610 may be, comprise, or be part of, a network router or modem. In particular monitoring device 610 may be part of a network router or modem through which a user device 700 connects to the internet.

Monitoring device 610 may be configured to store viewer information 612. Viewer information may be stored in a memory, such as memory 106. Viewer information 612 may identify one or more viewers of the display apparatus 200, for example viewers at a current time, or viewers at a previous time. Viewer information 612 may be determined by the monitoring device 610 itself, by the audience measurement system 610 generally, from user input, or by any other method. As discussed further below in relation to method 900, viewer information 612 may be automatically verified by monitoring device 610.

Monitoring device 610 comprises a wireless signal receiver 614. Wireless signal receiver 614 may be a radio wave signal receiver 112, as discussed above. Wireless signal receiver 614 may be a Wi-Fi signal receiver or a Bluetooth signal receiver. Wireless signal receiver 614 may be configured to receive signals from a user device 700. For example, wireless signal receiver 614 may be configured to receive signals from the user device 700 representing viewer information, such as viewer information entered by a user on the user device 700. As discussed further below, wireless signal receiver 614 may alternatively or additionally be a wireless signal sniffer, i.e. configured to capture and read wireless signals intended for a different device or system.

Audience measurement system 600 may in some examples comprise a remote server 620. The remote server 620 may be remote from the display apparatus 200 and monitoring device 610. The remote server 620 may be configured to receive signals from, and send signals to, the monitoring device 610. For example, remote server 620 and monitoring device 610 may communicate over the internet, or via any other network. Monitoring device 610 may transmit collected information to the remote server 620. Remote server 620 may store information received from the monitoring device 610, and may compare that information to information received from other monitoring devices 610 associated with other display apparatuses 200. In particular, remote server 620 may store viewer information 622, for example in a memory. Viewer information 622 may comprise information initially collected by monitoring device 610 and then transmitted to the remote server 620. Remote server 620 may also receive information directly from a user device 700 (e.g. a user's smart phone). For example, a user device 700 may run an application associated with the audience measurement system 600. A user may enter information (e.g. viewer information, which may then be stored as viewer information 622) into the application, which may then be transmitted, e.g. via the internet, to the remote server 620. In some examples, the remote server 620 may communicate some information received from the user device 700 to the monitoring device 610. This may be used for example where the monitoring device 610 does not have a direct communications link with the user device 700. Similarly the monitoring device 610 may send information (such as an initialization signal request as discussed above) to the user device 700 via the remote server 620.

### Method of Verifying Initial Viewer Information

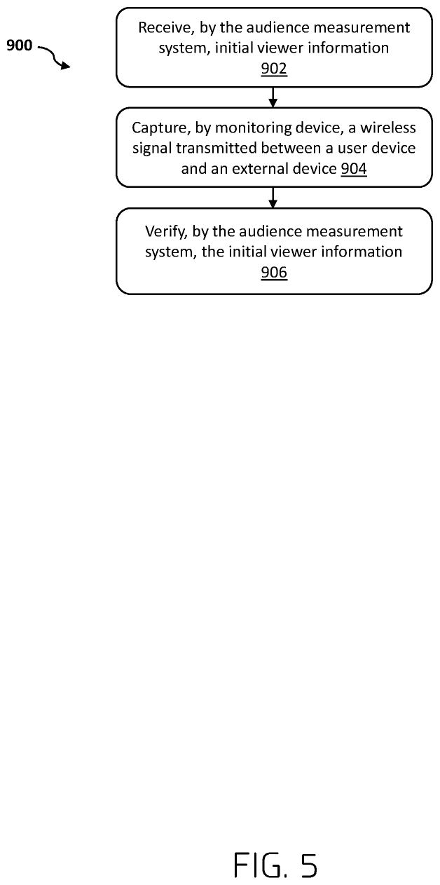

FIG. 5 illustrates an example method 900 for verifying viewer information. Method 900 may be performed entirely by the monitoring device 610, the monitoring device 610 comprising one or more processors (such as processor 104) and one or more computer readable media (such as memory 106) storing instructions which, when executed by the one or more processors, cause the monitoring device to perform the method 900. In alternative examples, method 900 may be performed by the audience measurement system 600 generally. For example some operations of method 900 may be performed by the monitoring device 610 whilst other operations are performed by remote server 620, with both monitoring device 610 and remote server 620 comprising a respective processor configured to perform the respective operations of method 900.

Method 900 comprises operation 902, at which initial viewer information 612, 622 is received by the audience measurement system 600. The initial viewer information 612, 622 may be received by the monitoring device 610 and/or by the remote server 620. The initial viewer information 612, 622 identifies a first user as viewing the display apparatus 200 (i.e. the first user is deemed to be a ‘viewer’ of the display apparatus 200, for example a current viewer or a viewer at a particular time). The initial viewer information 612, 622 may also specify one or more additional users as viewers. The initial viewer information 612, 622 may be or may have been generated based on information directed to the audience measurement system 600. In other words, the information may be intended for the audience measurement system 600, rather than intended for a different system (in contrast to operation 904 below). In some examples, the initial viewer information 612, 622 may be generated based at least in part on receiving a user input identifying the first user as viewing the display apparatus 200. For example, a user may enter viewer information into an application on a user device 700, which may then transmit the information to the audience measurement system 600, for example via wireless signal receiver 614 of monitoring device 610. The user may be the first user, identifying themself as a current viewer of the display apparatus 200. The user may be a different user identifying the first user as a viewer. Thus method 900 may automatically verify user-entered information, which conventional systems may treat as accurate. In other examples, initial viewer information may be automatically determined, for example based on determining that a user device 700 is proximate the monitoring device 610/display apparatus 200. Such methods may be based on a strength of signals received from the user device 700 (where such signals may be directed to the audience measurement system 600, e.g. as part of an identification protocol).

Method 900 comprises operation 904, at which a wireless signal transmitted between a user device 700 and an external system 800 is captured by the monitoring device 610. The wireless signal may be detected by wireless signal receiver 614, which may then generate an electrical representation of the signal which may be received at a processor of the monitoring device 610. In some examples the wireless signal may be transmitted by the user device 700, and may be directed to the external system 800. In other examples the wireless signal may be transmitted from the external system 800 and may be directed to the user device 700. Although described here as capturing a wireless signal, other examples may instead (or in addition) capture a wired signal transmitted between the user device 700 and an external system 800, for example a signal transmitted over a wired network connection (e.g. ethernet connection). Method 900 may verify the audience information in operation 906 below based at least in part on the captured wired signal.

The external system may be a system unassociated with the audience measurement system 600. The external system 800 may be a network router or modem. The external system 800 may be a remote system, such as a remote server. In such cases the user device 700 may first communicate with a local router or modem, which may then transmit the information content of the wireless signal to the remote server, for example over the internet. In some examples, the external system 800 may be associated with streaming media. In some examples, the external system 800 and the monitoring device 610 (or remote server 620) may both be separate components a wider device/system. In such cases, monitoring device 610 still captures/intercepts wireless signals that were intended to be received directly by the external system 800.

Thus, the monitoring device 610 acts as a wireless signal sniffer. In particular examples, the wireless signal may be a Wi-Fi signal. The monitoring device 610 may therefore act as a Wi-Fi sniffer, capturing and reading Wi-Fi signals that were not intended for the monitoring device 610 or for the audience measurement system 600 more generally. For example, operation 904 may comprise receiving the wireless signal at the monitoring device 610 and generating a copy of at least a portion of the wireless signal. The copy may then be transmitted such that the information contained in the wireless signal continues on to its intended destination. In other examples the monitoring device 610 may intercept the wireless signal, blocking it from reaching its destination. By such methods, neither the user nor the user device 700 need take any special action to enable verification of the initial viewer information 610. For example, user device 700 does not have to transmit any dedicated signals to the audience measurement system 600. Instead, monitoring device 610 makes use of incidental signals that may be transmitted to or from the user device 700 in the normal course of its operation. Such incidental signals may relate to an operating system operating on the user device 700, and/or to one or more applications running on the user device 700 that are unassociated with the audience measurement system 600.

Method 900 further comprises operation 906. Operation 906 comprises verifying, by the audience measurement system 600, the initial viewer information 612, 622 based at least in part on the wireless signal. For example, operation 906 may comprise determining, based at least in part on the wireless signal, that the initial viewer information is incorrect, or is correct. If the initial viewer information 612, 622 is incorrect, operation 906 may further comprise generating updated viewer information 612, 622. The updated viewer information may be stored at the monitoring device 610, and/or may be transmitted to remote server 620. Operation 906 may be performed by the monitoring device 610, the remote server 620, or any other component of the audience measurement system 600.

Where operation 904 involves copying a data packet of the wireless signal, operation 906 may involve analyzing the copy of the packet. For example, operation 906 may comprise identifying the user device 700 transmitting/receiving the wireless signal based on a source address or destination address of the data packet. The source/destination address of the packet may be compared to a known address of user devices 700 to determine which user device 700 the wireless signal is associated with. The audience measurement system 600 may maintain a list of user devices 700 and associated users, and so by identifying a user device 700 from the wireless signal the system 600 may identify an associated user. Operation 906 may comprise comparing users identified with the initial viewer information 612, 622 with the user of the user device 700 associated with the wireless signal. The packet may further be analyzed to determine content associated with the packet, for example determining if the packet relates to streaming media.

In some examples, it may be determined that the wireless signal is transmitted by a user device 700 associated with the first user, i.e. the first user listed in the initial viewer information 612, 622. Verifying the initial viewer information 612, 622 may then comprise determining, by the audience measurement system 600, and based at least in part on the wireless signal, that the first user is not actually viewing the display apparatus 200. If such a determination is made, operation 906 may further comprise removing, by the audience measurement system 600, the first user from the initial viewer information 612, 622. In other words, it may be as if the first user was never included in the viewer information 612, 622, improving the accuracy of the recorded viewer information.

On the other hand, it may be determined, based at least in part on the wireless signal, that the first user is in fact viewing the display apparatus 200. In such a case verifying the initial viewer information 612, 622 may comprise marking the initial viewer information 612, 622 as correct, or otherwise leaving the initial viewer information 612, 622 unmodified.

In some cases, a first user may be listed in the initial viewer information, either by the/a user or automatically. For example the first user may be near the display apparatus 200, and so it may initially be assumed that they are viewing the display apparatus 200. However, the first user may in fact be watching streaming media on their user device 700. As such, the first user may not actually be engaging with content on the display apparatus 200, and so should not be listed as a viewer. Accordingly, in some examples operation 906 may comprise determining that the first user is not viewing the display apparatus 200 based on determining, by the audience measurement system 600, that the wireless signal is associated with streaming media displayed on the user device 700. For example, a data packet of the wireless signal may be read to identify a source/destination address associated with the external system 800. The address of the external system 800 may then be compared to a known list of addresses of servers associated with streaming media. If the packet address matches an address on the list, it may be determined that the user device 700 is displaying streaming media. Alternatively or additionally, a payload of the data packet may be analyzed to determine if it relates to streaming media. Such examples may automatically check if a user is really watching the display apparatus 200, and automatically correct the viewer information 612, 622 if they are not.

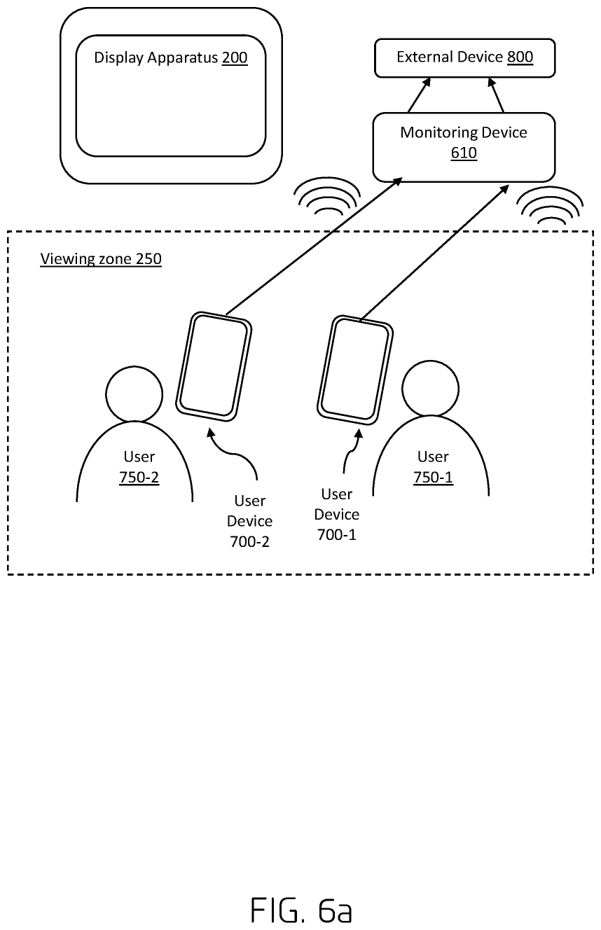

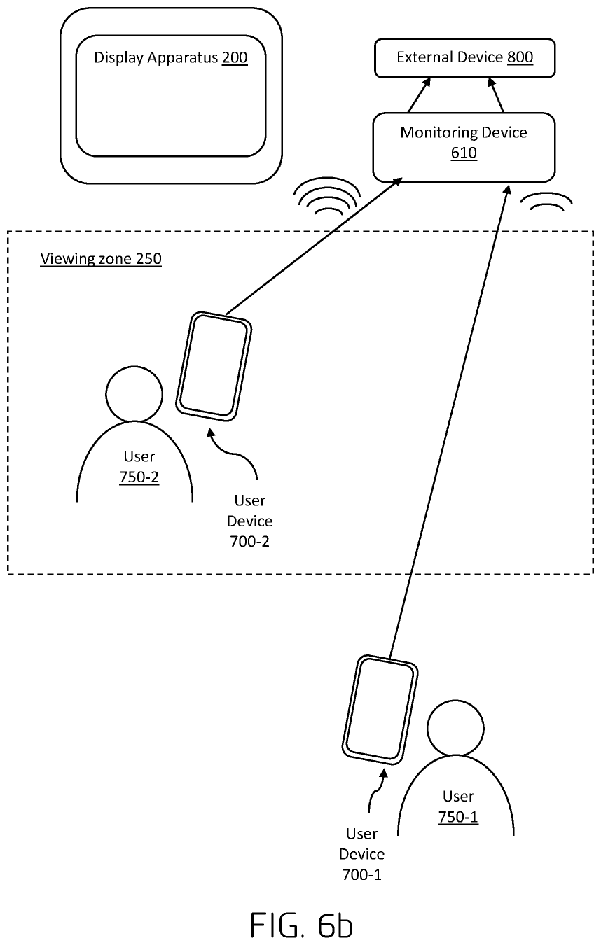

FIGS. 6a and 6b illustrate a further example of determining that a user is not actually watching the display apparatus 200, based on automatically detecting that a user identified in the initial viewer information 612, 622 is not actually near the display apparatus 200, and so is likely not watching content on the display apparatus 200.

FIG. 6a shows a first user 750-1 and a second user 750-2 in a defined viewing zone 250 proximate the display apparatus 200. The viewing zone may comprise a range of positions within a threshold distance of the display apparatus 200 and/or monitoring device 610. Although illustrated as a rectangle, the viewing zone 250 may have any shape and size as desired, for example selected to represent an area where it is expected viewers of the display apparatus 200 will be located. The viewing zone 250 may be pre-set by the manufacturer of the monitoring device 610, or may be defined by the user on location, for example during an initial set-up of the monitoring device 610.

Each user 750-1, 750-2 has a respective user device 700-1, 700-2 with them in the viewing zone 250. The user devices 700-1, 700-2 transmit wireless (e.g. Wi-Fi) signals directed to an external device 800. These wireless signals may be captured by the monitoring device 610. The monitoring device 610 determines a signal strength of each wireless signal, for example a signal-to-noise ratio. In the illustrated example, both user devices 700-1, 700-2 are within the viewing zone 250, and so the signal strength of both wireless signals is strong.

FIG. 6b illustrates an example where the first user 750-1 has left the viewing area 250, taking their user device 700-1 with them. The first user device 700-1 may continue to send wireless signals directed to the external system 800, and at least some of these wireless signals may still be captured by the monitoring device 610. However, the first user device 700-1 is now further from the monitoring device 610. As a result, the strength of a wireless signal from the first user device 700-1 is now reduced compared to its previous strength. The monitoring device 610 may use this reduction in signal strength to determine that the first user device 700-1, and hence first user 750-1, has left the viewing area 250. The monitoring device 610 may thus determine that first user 750-1 is not in fact viewing the display apparatus 200. For example, monitoring device 610 may compare a change in the signal strength (e.g. absolute change, proportional change) to a threshold associated with the boundary of the viewing zone 250. The viewing zone 250 may itself be defined by a predetermined threshold for comparing changes wireless signals. In such examples, monitoring device 610 may deem the first user to not be viewing the display apparatus 200 only if the user device 700-1 is outside of the viewing zone 250 for more than a predetermined minimum amount of time. For example, monitoring device 610 may capture multiple signals from user device 700-1 over a period of time to determine if user device 700-1 remains outside of the viewing zone 250. The minimum amount of time may be 2 minutes, or 5 minutes, or 10 minutes, or any other amount of time.

Accordingly, in some examples determining that the first user 750-1 is not viewing the display apparatus 200 may comprise determining, based at least in part on a strength of the wireless signal captured in operation 804, that the user device 700-1 associated with the first user 750-1 is outside of a viewing zone 250 associated with the display apparatus 200. In an example, the monitoring device captures a first wireless signal and a second wireless signal from the first user device 700-1. A difference between the strength of the first wireless signal and a strength of the second wireless signal is determined. It can then be determined, based at least in part on the difference, that the second wireless signal was transmitted by the user device 700-1 from outside of the viewing zone 250. In such a case the first user 750-1 may be removed from the initial viewer information 612, 622 (i.e. correcting the initial information). In alternative examples updated viewer information may be generated, rather than replacing the initial information. Determining movement of a user device 700 based on changes in signal strength of signals from the same user device 700, rather than using an absolute signal strength, has the advantage of controlling for inherent differences in signal strengths of signals transmitted by different types of user device 700, for example because of different transmission powers of different user devices 700.

In some examples, the monitoring device may store a strength of a wireless signal associated with the first wireless signal, i.e. the signal received when the first user device 700-1 was in the viewing zone 250. For example, the first wireless signal may be captured during an initial set-up of the monitoring device 610, or when adding the first user 750-1 as a user in the audience measurement system 600. This stored signal strength may then be used to determine whether future signals received from the first user device are sent from within or without the viewing zone 250, and thus to verify whether the first user 750-1 is watching the display apparatus 200.

In some examples, when it is determined that a user device 700-1 has left (or has entered) the viewing area 250, an additional check may be performed to confirm that the user 750-1 is no longer viewing the display apparatus 200. For example, verifying the initial viewer information may comprise both determining, based on signal strength, that the user device 700-1 of the first user 750-1 is inside/outside of a viewing zone 250 and determining that a signal transmitted to/from a computing device associated with the first is associated with streaming media. The computing device associated with the first user 750-1 may be the user device 700-1, and detecting the signal transmitted to/from said device may comprise the wireless sniffing discussed above. In other examples, the computing device (which may be user deice 700-1) may have a wired network connection, for example to a modem. In such cases the signal transmitted to/from the computing device may be sent via the wired connection, rather than wirelessly. The monitoring device 610 (e.g. where at least part of the monitoring device 610 is incorporated into the router/modem) may receive and analyze said wired signal similarly to the method discussed above for wireless signals to determine if the signal is associated with streaming media. In such examples the combination of the two determinations may provide a higher certainty that the first user really is, or is not, viewing the display apparatus 200, improving the accuracy of the data collected by the audience measurement system 600. For example, methods may determine that the first user 750-1 has left the viewing area 250, and then determine that a computing device of the first user 750-1 is associated with steaming media (e.g. within a predetermined time period of the first user 750-1 leaving the viewing zone 250), providing greater certainty that the first user is no longer viewing the display apparatus 200. On the other hand, method may detect that a computing device associated with the first user 750-1 which was transmitting/receiving signals associated with streaming media has stopped doing so, and that the first user 750-1 has entered the viewing zone 250 (e.g. within a predetermined time period of the end of streaming media signals). In such cases the monitoring device 610 may be more certain that the first user 750-1 is now viewing the display apparatus 200.

As a corollary to removing a user from the initial viewing information 612, methods of the present description may alternatively or additionally add a user that was not included in the initial viewer information 612. For example, operation 906 of method 900 may comprise determining that the captured wireless signal is associated with the second user device 700-2 of the second user 700-2. If the second user 750-2 was not included as a viewer in the initial viewer information 612, 622, the initial viewer information 612, 622 may be corrected to include the second user 700-2. In some examples, it may be determined that the second user 750-2 is viewing the display apparatus 200 by determining, based at least in part on a strength of the wireless signal, that the second user device 700-2 is within the viewing zone 250 associated with the display apparatus 200, as illustrated in FIGS. 6a and 6b.

At least some aspects of the examples described herein with reference to FIGS. 1-6b comprise computer processes performed in one or more processing systems and/or processors. However, in some examples, the disclosure also extends to computer programs, particularly computer programs on or in an apparatus, adapted for putting the disclosure into practice. The program may be in the form of non-transitory source code, object code, a code intermediate source and object code such as in partially compiled form, or in any other non-transitory form suitable for use in the implementation of processes according to the disclosure. The apparatus may be any entity or device capable of carrying the program. For example, the apparatus may comprise a storage medium, such as a solid-state drive (SSD) or other semiconductor-based RAM; a ROM, for example, a CD ROM or a semiconductor ROM; a magnetic recording medium, for example, a floppy disk or hard disk; optical memory devices in general; etc.

The above embodiments are to be understood as illustrative examples of the present disclosure. Further embodiments are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of embodiments, which is defined in the accompanying claims.

The description contains the following numbered clauses:
1. A monitoring device for monitoring a status of a display apparatus, the monitoring device comprising: an infra-red, IR, receiver for detecting an IR signal transmitted from a remote control; a processor configured to determine, from the IR signal, an operating instruction for operating the display apparatus, wherein the operating instruction comprises a channel change instruction and/or a power instruction; and a memory configured to store a current status of the display apparatus, the current status comprising a channel displayed on the display apparatus and/or a power status; wherein the processor is configured to determine an updated status of the display apparatus based at least in part on the operating instruction, and to replace the current status stored in the memory with the updated status.
2. The monitoring device of clause 1, wherein the processor is configured to determine the updated status of the display based at least in part on the operating instruction and on the current status stored in the memory.
3. The monitoring device of clause 1 or clause 2, wherein: the operating instruction comprises the channel change instruction; the channel change instruction comprises a channel up instruction or a channel down instruction; and the processor is configured to determine an updated channel displayed on the display apparatus based at least in part on the current status stored in the memory and on the channel up instruction or channel down instruction.
4. The monitoring device of any preceding clause, wherein the processor is configured to perform an initialization operation to initialize the current status stored in the memory, the initialization operation comprising: receiving an initialization signal from a user device, the initialization signal comprising information specifying a channel for display on the display apparatus and/or information specifying a power status of the display apparatus; determining, based at least in part on the initialization signal, an initial status of the display apparatus, the initial status comprising the channel currently displayed on the display apparatus and/or the current power status; and storing the initial status in the memory as the current status.
5. The monitoring device of clause 4, wherein the monitoring device is configured to request the initialization signal from the user device.
6. The monitoring device of any preceding clause, wherein: the monitoring device further comprises a radio wave receiver for receiving a radio wave signal from the or a user device; and the processor is configured to determine a further updated status of the display apparatus based at least in part on the radio wave signal.
7. The monitoring device of clause 6, wherein the radio wave signal comprises an operating instruction for operating the display apparatus, or wherein the radio wave signal comprises user-entered information indicating a current status of the display apparatus.
8. The monitoring device of clause 6 or clause 7, wherein the radio wave signal is associated with an application operating on the user device, the application associated with controlling and/or monitoring the display apparatus.
9. The monitoring device of any of clauses 6 to 8, wherein the radio wave signal is a Wi-Fi signal or a Bluetooth signal.
10. The monitoring device of any of clauses 4 to 9, wherein the user device is a computing device, a portable computing device, a smart phone, a tablet computer, a portable computer, or a wearable device.
11. The monitoring device of any preceding clause, wherein the IR signal comprises a signal code representing the operating instruction, and wherein the processor is configured to determine the operating instruction from the IR signal by: comparing the signal code to a plurality of stored codes, each stored code associated with a respective known operating instruction; identifying a matching code from the plurality of stored codes based on a similarity between the signal code and the matching code; and identifying the known operating instruction associated with the matching code as the operating instruction of the IR signal.
12. The monitoring device of clause 11, wherein the processor is configured to: receive an identification of the display apparatus from a user device; and identify the plurality of stored codes based on the identification of the display apparatus.
13. The monitoring device of any preceding clause, wherein the remote control directly controls the display apparatus.
14. The monitoring device of any preceding clause, wherein the processor is configured to replace the current status with the updated status by storing in the memory: the current status as a previous status; and a time associated with the previous status.
15. The monitoring device of any preceding clause, wherein the monitoring device further comprises a network connection for transmitting a status of the display apparatus to a remote server.
16. The monitoring device of any preceding clause, wherein the processor is configured to identify, based on the current status stored in the memory and a time associated with the status, content displayed on the display apparatus.
17. The monitoring device of any preceding clause, wherein the memory is further configured to store viewer information associated with the status of the display apparatus.
18. The monitoring device of any preceding clause, wherein the display apparatus is or comprises one or more of a television, a non-smart television, a smart television, a set-top box, and a streaming device.
19. The monitoring device of any preceding clause, wherein the monitoring device is a television audience measurement system.
20. A computer-implemented method for monitoring a status of a display apparatus, the method comprising: receiving, at a monitoring device separate to the display apparatus, an infra-red, IR, signal transmitted from a remote control to the display apparatus; determining, from the IR signal, an operating instruction for operating the display apparatus, wherein the operating instruction comprises a channel change instruction and/or a power instruction; determining, based at least in part on the operating instruction, a current status of the display apparatus, the current status comprising a channel displayed on the display apparatus and/or a power status; and storing the current status of the display apparatus in a memory.
21. The method of clause 20, comprising determining the current status based at least in part on the operating instruction and a previous status stored in the memory.
22. The method of clause 20 or clause 21, further comprising: receiving, by the monitoring device, a wireless signal from a user device; and determining an updated status of the display apparatus based on the wireless signal.
23. The method of any of clauses 20 to 22, further comprising: receiving an initialization signal, the initialization signal comprising information specifying a channel for display on the display apparatus and/or information specifying a power status of the display apparatus; identifying, from the initialization signal, the channel currently displayed on the display apparatus and/or the current power status of the display apparatus; and storing an initial status in the memory, the initial status comprising the channel currently displayed and/or the current power status as the current status of the display apparatus.
24. The method of clause 23, further comprising requesting the initialization signal from a user device.
25. The method of any of clauses 20 to 24, further comprising transmitting the current status of the display apparatus to a remote server.
26. The method of any of clauses 20 to 25, further comprising identifying, based on a status of the display apparatus and on a time associated with the status, content displayed on the display apparatus.
27. The method of any of clauses 20 to 26, further comprising storing a previous status of the display apparatus, and a time associated with the previous status.
28. A computer program comprising instructions, which, when the program is executed by a computer, cause the computer to perform the method of any of clauses 20 to 27.
29. A computer-readable medium comprising instructions which, when executed by a computer, cause the computer to perform the method of any of clauses 20 to 27.
30. A computer-implemented method of verifying, in an audience measurement system, viewer information associated with a display apparatus, wherein the audience measurement system is for monitoring viewers of broadcast media, and wherein the method comprises: receiving, by the audience measurement system, initial viewer information, the initial viewer information identifying a first user as viewing the display apparatus; capturing, by a monitoring device of the audience measurement system associated with the display apparatus, a wireless signal transmitted between a user device and an external system; and verifying, by the audience measurement system, the initial viewer information based at least in part on the wireless signal.
31. The method of clause 30, wherein the initial viewer information is generated based on information directed to the audience measurement system.
32. The method clause 30 or clause 31, wherein the initial viewer information is generated based at least in part on receiving a user input identifying the first user as viewing the display apparatus.
33. The method of any of clauses 30 to 32, wherein the user device is associated with the first user, and wherein verifying the initial viewer information comprises determining, by the audience measurement system, and based at least in part on the wireless signal, that the first user is not viewing the display apparatus.
34. The method of clause 34, comprising removing, by the audience measurement system, the first user from the initial audience information.
35. The method of clause 33 or clause 34, wherein determining that the first user is not viewing the display apparatus comprises determining, based at least in part on a strength of the wireless signal, that the user device is outside of a viewing zone associated with the display apparatus.
36. The method of clause 35, wherein the wireless signal is a first wireless signal, and wherein the method comprises: receiving a second wireless signal transmitted by the user device subsequent to the first wireless signal; determining a difference between the strength of the first wireless signal and a strength of the second wireless signal; and determining, based at least in part on the difference, that the second wireless signal was transmitted by the user device from outside of the viewing zone.
37. The method of clause 33 or clause 34, wherein determining that the first user is not viewing the display apparatus comprises determining, by the audience measurement system, that the wireless signal is associated with streaming media displayed on the user device.
38. The method of clause 37, wherein the wireless signal comprises a data packet, and wherein determining that the wireless signal is associated with streaming media comprises identifying a destination address of the data packet, and/or analyzing a payload of the data packet.
39. The method of any of clauses 30 to 32, wherein the user device is associated with a second user not identified in the initial viewer information, and wherein verifying the initial viewer information comprises determining, by the audience measurement system, and based at least in part on the wireless signal, that the second user is viewing the display apparatus.
40. The method of clause 39, wherein determining that the second user is viewing the display apparatus comprises determining, based at least in part on a strength of the wireless signal, that the user device is within a viewing zone associated with the display apparatus.
41. The method of clause 39 or clause 40, comprising adding, by the audience measurement system, the second user to the initial viewer information.
42. The method of any preceding clause, wherein: capturing the wireless signal comprises receiving the wireless signal at the monitoring device and generating a copy of at least a portion of the wireless signal; and verifying the initial viewer information based at least in part on the wireless signal comprises analyzing the copy of the at least a portion of the wireless signal.
43. The method of any preceding clause, wherein the monitoring device is, comprises, or is part of a network router or modem; or wherein the monitoring device is a stand-alone monitoring device associated with the display apparatus.
44. The method of any preceding clause, wherein the wireless signal comprises a data packet, and wherein the method comprises identifying the user device transmitting the wireless signal from a source address of the data packet.
45. The method of any preceding clause, wherein verifying the initial viewer information comprises determining, based at least in part on the wireless signal, that the initial viewer information is not correct.
46. The method of clause 45, further comprising generating updated viewer information.
47. The method of any preceding clause, wherein the wireless signal is a Wi-Fi signal.
48. The method of any preceding clause, wherein the display apparatus is or comprises one or more of a television, a non-smart television, a smart television, a set-top box, and a streaming device.
49. A monitoring device for monitoring a display apparatus, the monitoring device comprising: a wireless signal receiver for detecting a wireless signal transmitted by a user device; one or more processors; and one or more computer-readable media storing instructions that, when executed, cause the monitoring device to perform the method of any of clauses 30 to 48.
50. The device of clause 49, wherein the device is configured to determine a status of the display apparatus.
51. An audience measurement system comprising the monitoring device of clause 49 or clause 50.
52. An audience measurement system comprising: one or more processors; and one or more computer-readable media storing instructions that, when executed, cause the monitoring device to perform the method of any of clauses 30 to 48.
53. The audience measurement system of clause 52, comprising a monitoring device for monitoring a display apparatus, wherein the monitoring device comprises a wireless signal receiver for receiving a wireless signal transmitted by a user device.
54. A computer program comprising instructions, which, when the program is executed by a computer, cause the computer to perform the method of any of clauses 30 to 48.
55. A computer-readable medium comprising instructions which, when executed by a computer, cause the computer to perform the method of any of clause 30 to 48.

What is claimed is:

1. A monitoring device for monitoring a status of a display apparatus, the monitoring device comprising:
an infra-red, IR, receiver for detecting an IR signal transmitted from a remote control;
a radio wave receiver for receiving a radio wave signal from a user device;
a memory configured to store a current status of the display apparatus, the current status comprising a channel displayed on the display apparatus and a power status; and
a processor configured to determine: (i) from the IR signal, a first operating instruction for operating the display apparatus, wherein the first operating instruction comprises a first channel change instruction and/or a first power instruction, and (ii) based at least in part on the radio wave signal, determine a second operating instruction for operating the display apparatus, wherein the second operating instruction comprises a second channel change instruction and/or a second power instruction,
wherein the processor is further configured to:
determine a first updated status of the display apparatus based at least in part on the first operating instruction;
determine a second updated status of the display apparatus based at least in part on the second operating instruction;
at a first time, replace the current status stored in the memory with one of the first or second updated statuses based on which of the IR signal and the radio wave signal is received first; and
at a second time after the first time, replace the one of the first or second updated statuses stored in memory with the other of the first or second updated statuses based on which of the IR signal and the radio wave signal is received second.

2. (canceled)

3. The monitoring device of claim 1, wherein:
the first or second operating instruction comprises the respective first or second channel change instruction;
the first or second channel change instruction comprises a respective first or second channel up instruction or a respective first or second channel down instruction; and
the processor is configured to determine an updated channel displayed on the display apparatus based at least in part on the current status stored in the memory and on the first or second channel up instruction or first or second channel down instruction.

4. The monitoring device of claim 1, wherein the processor is configured to perform an initialization operation to initialize the current status stored in the memory, the initialization operation comprising:
receiving an initialization signal from the user device, the initialization signal comprising information specifying a channel for display on the display apparatus and/or information specifying a power status of the display apparatus;
determining, based at least in part on the initialization signal, an initial status of the display apparatus, the initial status comprising the channel currently displayed on the display apparatus and/or the current power status; and
storing the initial status in the memory as the current status.

5. The monitoring device of claim 4, wherein the monitoring device is configured to request the initialization signal from the user device.

6. (canceled)

7. (canceled)

8. The monitoring device of claim 1, wherein the radio wave signal is associated with an application operating on the user device, the application associated with controlling and/or monitoring the display apparatus.

9. The monitoring device of claim 1, wherein the radio wave signal is a Wi-Fi signal or a Bluetooth signal.

10. The monitoring device of claim 1, wherein the user device is a computing device, a portable computing device, a smart phone, a tablet computer, a portable computer, or a wearable device.

11. The monitoring device of claim 1, wherein the IR signal comprises a signal code representing the first operating instruction, and wherein the processor is configured to determine the first operating instruction from the IR signal by:
comparing the signal code to a plurality of stored codes, each stored code associated with a respective known operating instruction;
identifying a matching code from the plurality of stored codes based on a similarity between the signal code and the matching code; and
identifying the known operating instruction associated with the matching code as the first operating instruction of the IR signal.

12. The monitoring device of claim 11, wherein the processor is configured to:
receive an identification of the display apparatus from a the user device; and
identify the plurality of stored codes based on the identification of the display apparatus.

13. The monitoring device of claim 1, wherein the remote control directly controls the display apparatus.

14. The monitoring device of claim 1, wherein the processor is configured to replace the current status with the first or second updated status by storing in the memory: the current status as a previous status; and a time associated with the previous status.

15. The monitoring device of claim 1, wherein the monitoring device further comprises a network connection for transmitting a status of the display apparatus to a remote server.

16. The monitoring device of claim 1, wherein the processor is configured to identify, based on the current status stored in the memory and a time associated with the current status, content displayed on the display apparatus.

17. The monitoring device of claim 1, wherein the memory is further configured to store viewer information associated with the status of the display apparatus.

18. (canceled)

19. (canceled)

20. A computer-implemented method for monitoring a status of a display apparatus, the method comprising:
receiving, at a monitoring device separate to the display apparatus, an infra-red, IR, signal transmitted from a remote control to the display apparatus;
determining, from the IR signal, a first operating instruction for operating the display apparatus, wherein the first operating instruction comprises a first channel change instruction and/or a first power instruction;
receiving, at the monitoring device, a radio wave signal from a user device;
determining, from the radio wave signal, a second operating instruction for operating the display apparatus, wherein the second operating instruction comprises a second channel change instruction and/or a second power instruction;
determining, based at least in part on the first operating instruction, a first status of the display apparatus, the first status comprising a first channel displayed on the display apparatus and/or a first power status;
determining, based at least in part on the second operating instruction, a second status of the display apparatus, the second status comprising a second channel displayed on the display apparatus and/or a second power status;
at a first time, storing in a memory, one of the first or second statuses based on which of the IR signal and the radio wave signal is received first; and
at a second time after the first time, replacing the one of the first or second statuses stored in the memory with the other of the first or second statuses based on which of the IR signal and the radio wave signal is received second.

21. The method of claim 20, comprising determining the first and/or second status based at least in part on the respective first and/or second operating instruction and a previous status stored in the memory.

22. (canceled)

23. The method of claim 20, further comprising:
receiving an initialization signal, the initialization signal comprising information specifying a channel for display on the display apparatus and/or information specifying a power status of the display apparatus;
identifying, from the initialization signal, a channel currently displayed on the display apparatus and/or a current power status of the display apparatus; and
storing an initial status in the memory, the initial status comprising the channel currently displayed and/or the current power status as a current status of the display apparatus.

24. The method of claim 23, further comprising requesting the initialization signal from the user device.

25. The method of claim 20, further comprising transmitting the first and/or second status of the display apparatus to a remote server.

26-28. (canceled)

29. A non-transitory computer-readable medium comprising instructions which, when executed by a computer, cause the computer to perform the method of claim 20.

30-55. (canceled)
